(19) United States
(12) Patent Application Publication
(10) Pub. No.: US 2013/0191575 A1
(43) Pub. Date: Jul. 25, 2013

(54) METHODS AND SYSTEMS FOR PROVIDING ALTERNATIVE STORAGE RESOURCES

(71) Applicant: HENDRICKS INVESTMENT HOLDINGS, LLC, Silver Spring, MD (US)

(72) Inventor: Stephen I. HASENEI, Silver Spring, MD (US)

(73) Assignee: HENDRICKS INVESTMENT HOLDINGS, LLC, Silver Spring, MD (US)

(21) Appl. No.: 13/722,918

(22) Filed: Dec. 20, 2012

Related U.S. Application Data
(60) Provisional application No. 61/578,686, filed on Dec. 21, 2011.

(51) Int. Cl. G06F 13/40

(52) U.S. Cl. CPC G06F 13/4081
USPC 710/303

(57) ABSTRACT

An engaged device that is only compatible with a specific retailer's operating system may be enclosed in a case together with a resource and/or other storage device so that content of the resource that is not compatible with the specific retailer's operating system, and that may not thereby be readily accessed by the engaged device, may be indirectly accessed by the engaged device. The engaged device may be coupled to a casing, and the casing may be coupled to a resource. As a result, the engaged device may indirectly access the resource.

### BACKGROUND OF THE INVENTION

1. Field of Invention

Aspects of the present invention relate to methods and systems for providing additional storage and/or other features to a processor device. More particularly, aspects of the present invention relate to providing features to allow additional capabilities, such as storage of non-compatible content, on a device.

2. Description of Related Art

Some large computer retailers and manufacturers mandate the use of specific content that is compatible only with the specific retailer's devices and operating system. For example, Apple Inc. of Cupertino, Calif., mandates that only content downloaded via an iTunes compatible format may be stored on an Apple device. Accordingly, in such situations, content purchased from retailers other than the specific retailer, such as Apple Inc., may only be accessed and/or stored on devices that are compatible with the specific retailer's operating system by using a web browser. As a result, a user may not be able to save content from a retailer other than the specific retailer on the user's device. For example, although content not purchased from Apple may be accessed on iOS, Apple's proprietary operating system, such non-Apple compatible content may not be saved on a device having Apple's operating system.

### SUMMARY OF THE INVENTION

In light of the above-described problems and unmet needs as well as others, an engaged device (e.g., a hand held or other device) that is only compatible with a specific retailer's operating system may be enclosed in a case (also interchangeably referred to herein as an “interface”) together with a storage device and/or other features (also interchangeably referred to herein as a “resource,” which may be proximate to or remote from the engaged device) so that content that is not compatible with storage via the specific retailer's operating system, and that may not thereby be stored on the engaged device, may be stored on the storage device or resource. According to various aspects, the storage device or resource may be accessed via one or more application programming interfaces (API) and/or hardware features of the specific retailer's operating system, and the storage device or resource may therefore be used to store and allow access to content that is not compatible with the specific retailer's operating system. Typical engaged devices usable in accordance with aspects of the present invention may include a personal computer (PC), a laptop computer, a minicomputer, mainframe computer, microcomputer, telephonic device, or wireless device, such as a personal digital assistant (“PDA”), other hand-held wireless device, and a smart device such as smart phone or a tablet.

According to various aspects, the additional storage or resource device may be contained in or coupled to an enclosure in which the engaged device is placed, and alternatively may consist of or include a storage device removable from the enclosure. According to various aspects, accessing the storage device or resource may be achieved via a Universal Serial Bus (USB) port, Bluetooth or other wireless interface, a Flexible Magnetic Interconnect (FMI) interface, and/or any other such accessing devices or features.

According to various aspects, in one example implementation, the additional storage device may be configured to allow the use of access control technologies, such as Digital Rights Management (DRM) solutions. Accordingly, DRM functionality may be achieved by using a separate partition to store content in conjunction with the enclosure. In addition, a separate application reader may also be provided to read the content stored in the additional storage device or resource.

Additional advantages and novel features of these aspects of the invention will be set forth in part in the description that follows, and in part will become more apparent to those skilled in the art upon examination of the following or upon learning by practice thereof.

### BRIEF DESCRIPTION OF THE DRAWINGS

Various example aspects of the systems and methods will be described in detail, with reference to the following figures, wherein:

FIGS. 1(a)-(e) are illustrations of various views of an example storage system or resource according to various aspects of the current invention;

FIGS. 2(a)-(e) are illustrations of various views of another example storage system or resource according to various aspects of the current invention;

FIG. 3 is a flow chart illustrating a method of operation of an example storage system or resource, according to various aspects of the current invention;

FIG. 4 presents an example system diagram of various hardware components and other features, for use in accordance with aspects of the present invention; and

FIG. 5 is a block diagram of various example system components, for use in accordance with an aspect of the present invention.

### DETAILED DESCRIPTION

These and other features and advantages in accordance with aspects of this invention are described in, or are apparent from, the following detailed description.

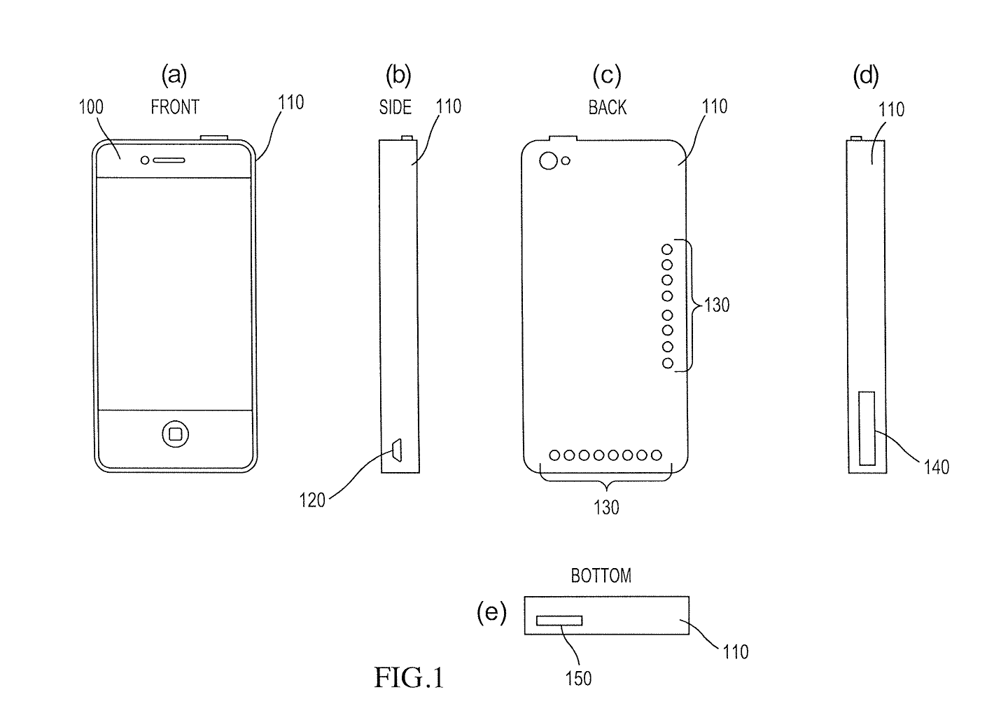

FIGS. 1(a)-(e) are illustrations of various views of an example storage system according to various aspects of the current invention. In FIG. 1(a), the front view of a device 100, (also alternatively or interchangeably referred to herein as an “engaged device”) such as, for example, a smart phone, engaged within a case 110 is illustrated. According to various aspects, the case 110 may also include an internal connection (not visible in this view) coupleable (e.g., via electrical or wireless coupling) to a port of the device 100, so that any devices contained within or accessible via the case 110 may communicate with or otherwise be accessed by the device 100. For example, the case 110 may include a device-approved connection to the device 100 such as, e.g. in the case of an iPhone, an Apple-approved connection to couple the case 110 to the device 100. As such, if the device 100 is not designed to cooperate with certain external devices, or to store non-approved data, then according to various aspects of the current invention, the device 100 may be enabled to indirectly cooperate with these non-approved or external devices that are otherwise accessible to the case 110 via the connection of the device 100 to the case 110. As a result, the device 100 may indirectly cooperate with such devices via internal connections in the case 110 or via external ports of the case 110, for example.

According to various aspects, the case 110 may be coupled to the device 100 via any one or more of a power input port of the device 100, an earphone port of the device 100, any other physical port present on the device 100, or wirelessly, for example. In one example implementation, the case 110 may be flexible and may include pin connectors and/or other connectors that are couplable to ports of the device 100. In operation, the case 110 may be flexed, for example, to engage the connector(s) of the case 110 with the port(s) of the device 100, and optionally, the case 110 may partially or wholly envelop portions of the device 100, including all of the device 100.

FIG. 1(b) illustrates a side view of the case 110 containing a device 100 (not visible in this view), and the case 110 may have a USB port 120, for example. Accordingly, a USB device, such as a USB storage device or drive, may be indirectly coupled to the device 100 via the USB port 120 of the case 110 via the above-discussed coupling between the case 110 and the device 100 and the coupling between the case 110 and the USB port 120. As a result, if the device 100 does not have a USB port 120, for example, the coupling of the device 100 to the case 110 may provide access to the device 100 via the USB port 120 of the case 110. Accordingly, the ability to store data on, or to access data from, a coupled USB drive while using the device 100 may be provided.

FIG. 1(c) illustrates a back view of the case 110 containing a device 100 (not visible in this view), according to various aspects of the current invention. In FIG. 1(c), the case 110 may also include an FMI interface 130, which may allow power delivery to the device 100 via the case 110, without directly connecting the device 100 to a power outlet, e.g., if no power outlet compatible with the device 100 is available.

FIG. 1(d) illustrates another side view of the case 110 containing a device 100 (not visible in this view), where the case 110 may include a Micro Secure Digital (SD) card slot 140. Accordingly, a Micro SD card, such as an SD storage device or drive, may be indirectly coupled to the device 100 via the Micro SD slot 140 of the case 110 via the above-discussed internal coupling between the case 110 and the device 100. As a result, if the device 100 does not have a Micro SD card slot, for example, the coupling of the device 100 to the case 110 may thereby provide indirect access to the device 100 via the Micro SD slot 140 of the case 110. As such, the capability to store data on, or to access data from, an SD card while using the device 100 may be enabled.

FIG. 1(e) illustrates a bottom view of the device 100 engaged with the case 110, according to various aspects of the current invention. In FIG. 1(e), an additional Micro SD card slot 150 is illustrated, and may provide similar functionality as discussed above with respect to FIG. 1(d). According to various aspects, although the illustrated ports are a USB port 120, an FMI interface 130 and Micro SD card slots 140 and 150, additional ports or interfaces may also be provided (including wireless and/or other non-physically coupled features) to allow storing and/or accessing of data from the device 100 via the case 110.

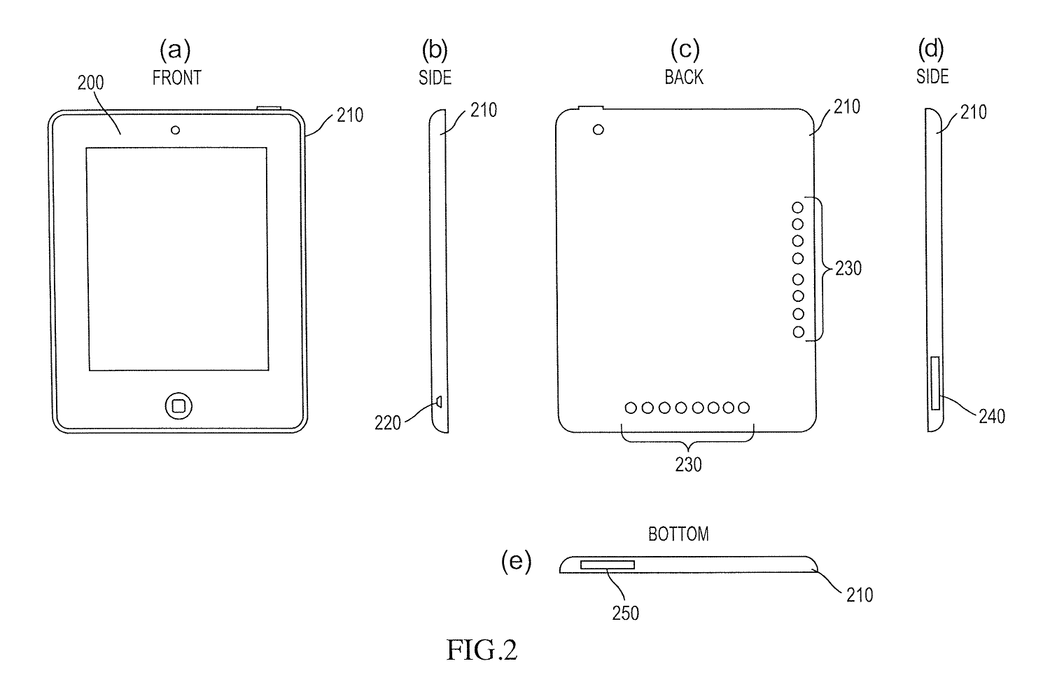

FIGS. 2(a)-(e) are illustrations of various views of another example storage system according to various aspects of the current invention. In FIG. 2(a), the front view of a device 200 such as, for example, a smart tablet, enclosed in a case 210 is illustrated. According to various aspects, the case 210 may also include an internal connection (not visible in this view) to a port of the device 200. For example, the case 210 may be coupled to the device 200 via a power input port of the device 200, via an earphone port, via any other port present on the device 200, and/or the case 210 may be coupled wirelessly or otherwise via a non-physical port connector to the device 200.

FIG. 2(b) illustrates a side view of the device 200 (not visible in this view) engaged with the case 210, the case 210 having a USB port 220. Accordingly, a USB device, such as a USB storage device or drive, may be indirectly coupled to the device 200 via the USB port 220 of the case 210 via the above-discussed coupling between the case 210 and the device 200. As a result, if the device 200 does not have a USB port, the coupling of the device 200 to the case 210 may provide indirect access for the device 200 to the USB port 220 of the case 210, and thus enable the device 200 to have access to storage or data on a USB drive or a USB storage device. Accordingly, if the device 200 is not designed to cooperate with certain external devices, or with non-approved content (e.g., storage of such non-approved content), then according to various aspects of the current invention, the device 200 may be enabled to cooperate with the external devices via the case 210.

FIG. 2(c) illustrates a back view of the device 200 (not visible in this view) engaged with the case 210, according to various aspects of the current invention. In FIG. 2(c), the case 210 also includes an FMI interface 230, which may allow powering of the device 200 via the case 210 without physically connecting the device 200 to a power outlet, e.g., if no power outlet compatible with the device 200 is available.

FIG. 2(d) illustrates another side view of the case 210 containing the device 200 (not visible in this view), where the case 210 includes a Micro SD card slot 240. Accordingly, a Micro SD card, such as an SD storage device or drive, may be indirectly coupled to the device 200 via the Micro SD slot 240 of the case 210 via the above-discussed coupling between the case 210 and the device 200. As a result, if the device 200 does not have a Micro SD card slot, for example, the coupling of the device 200 to the case 210 may enable access by the device 200 to the Micro SD slot 240 of the case 210, and thus enable storage of data and/or access of data on an SD card while using the device 200.

FIG. 2(e) illustrates a bottom view of the case 210 containing the device 200 (not visible in this view), according to various aspects of the current invention. In FIG. 2(e), an additional Micro SD card slot 250 is illustrated, and may provide similar functionality as discussed above with respect to FIG. 2(d). According to various aspects, although the illustrated ports are a USB port 220, an FMI interface 230 and Micro SD card slots 240 and 250, additional ports or interfaces that may allow storing and accessing of data may be provided on the case 210 to allow accessing and/or storing data by the device 200.

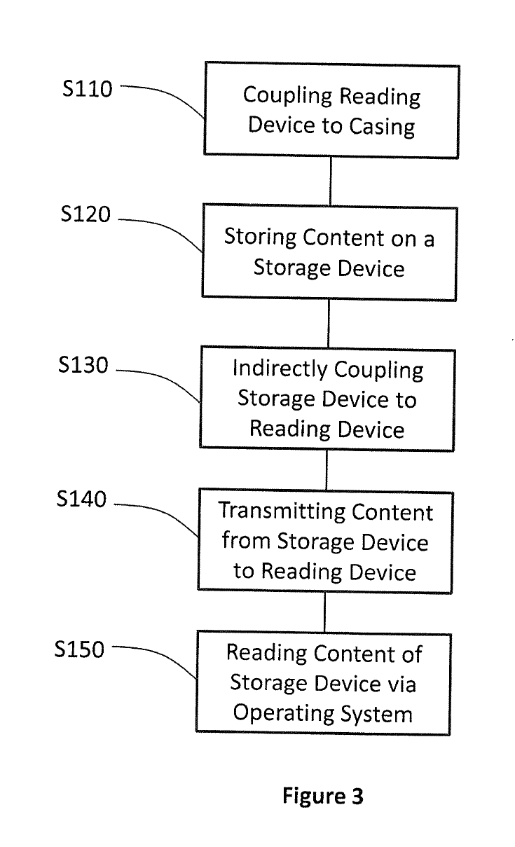

FIG. 3 is a flow chart illustrating an example method of operation according to various aspects of the current invention. In FIG. 3, an engaged device, such as a proprietary engaged device, may be coupled to a casing at S110. According to various aspects, the engaged device may be coupled to the casing via a power input port of the engaged device, an earphone port of the engaged device, any other physical port of the engaged device, or wirelessly, for example. At S120, content that has been generated, purchased or copied, may be stored on a storage device separate from the engaged device, and the content may be content that is not compatible with the proprietary engaged device, where the engaged device is not configured to access the content stored on the storage device. According to various aspects, the storage device may be part of or comprise a computer, a USB drive, a Micro SD card, or other data storage device or repository.

According to various aspects, at S130, the storage device may be coupled to an engaged device, such as a smart device (e.g., Apple iPhone or tablet), via an intermediate coupling device. For example, the intermediate coupling device may be the above-discussed casing that is coupled to, or partially or wholly encloses the engaged device, the casing including couplings to interconnect with one or more ports of the engaged device. According to various aspects, one or more storage devices such as a USB drive, an FMI interface or a Micro SD card, or the like, may be incorporated with or coupled to the casing, via a physical coupling, via Bluetooth, other wireless connection, or via any other suitable coupling feature(s). As discussed above, the casing may be coupled to the engaged device via a power port of the engaged device, an earphone port of the engaged device, or any other suitable port of the engaged device that may be used as a coupling port of the engaged device. For example, if the engaged device is an Apple device and the coupling port of the casing is an FMI interface, the FMI interface of the casing may be coupled to the Apple 30 PIN of the device. Alternatively, the casing may be coupled to the engaged device wirelessly or via other non-physical port connection.

According to various aspects, once the casing and the engaged device are coupled as discussed at S110, and the storage device and the engaged device may be coupled as discussed at S130, transmission of content between the engaged device and the storage device or resource may be enabled at S140. According to various aspects, when content stored in the storage device has been accessed by or transmitted to the engaged device, the content may be displayed or otherwise accessed by a user via the device at S150. As a result, content that initially could not have been copied onto or otherwise accessed by the engaged device, for example, because the engaged device is not configured to allow connection to an external storage device or has software features preventing copying to the engaged device form the external storage device, may now be accessed by the engaged device.

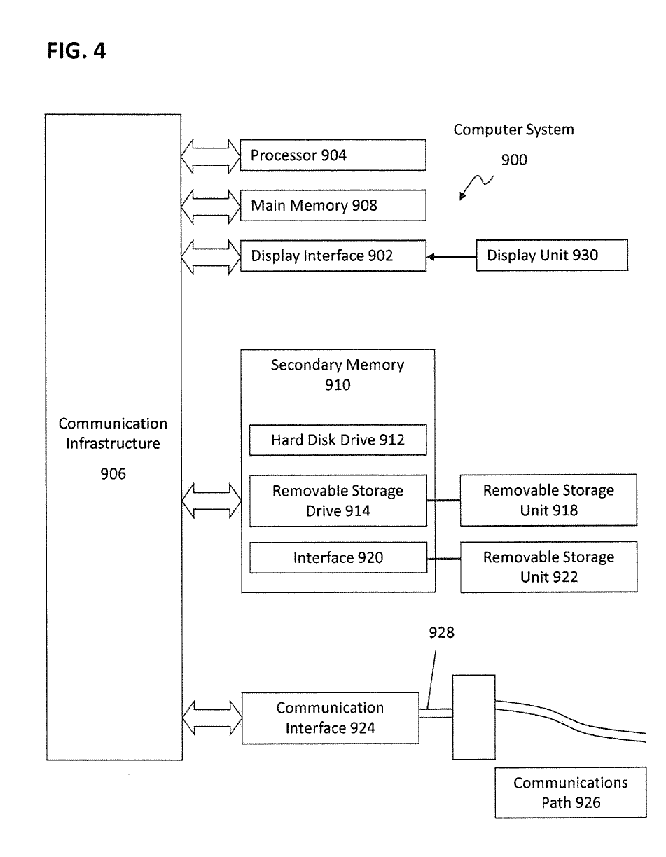

FIG. 4 presents an example system diagram of various hardware components and other features, for use in accordance with an aspect of the present invention. Aspects of the present invention may be implemented using hardware, software, or a combination thereof and may be implemented in one or more computer systems or other processing systems. In one variation, aspects of the present invention are directed toward one or more computer systems capable of carrying out the functionality described herein. An example of such a computer system 900 is shown in FIG. 4.

Computer system 900 includes one or more processors, such as processor 904. The processor 904 is connected to a communication infrastructure 906 (e.g., a communications bus, cross-over bar, or network). Various software aspects are described in terms of this example computer system. After reading this description, it will become apparent to a person skilled in the relevant art(s) how to implement aspects of the invention using other computer systems and/or architectures.

Computer system 900 can include a display interface 902 that forwards graphics, text, and other data from the communication infrastructure 906 (or from a frame buffer not visible in this view) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. Aspects of the invention are directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features in accordance with aspects of the present invention, as discussed herein. In particular, the computer programs, when executed, enable the processor 910 to perform the features in accordance with aspects of the present invention. Accordingly, such computer programs represent controllers of the computer system 900.

In an example variation where aspects of the present invention are implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another example variation, aspects of the present invention are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects of the present invention are implemented using a combination of both hardware and software.

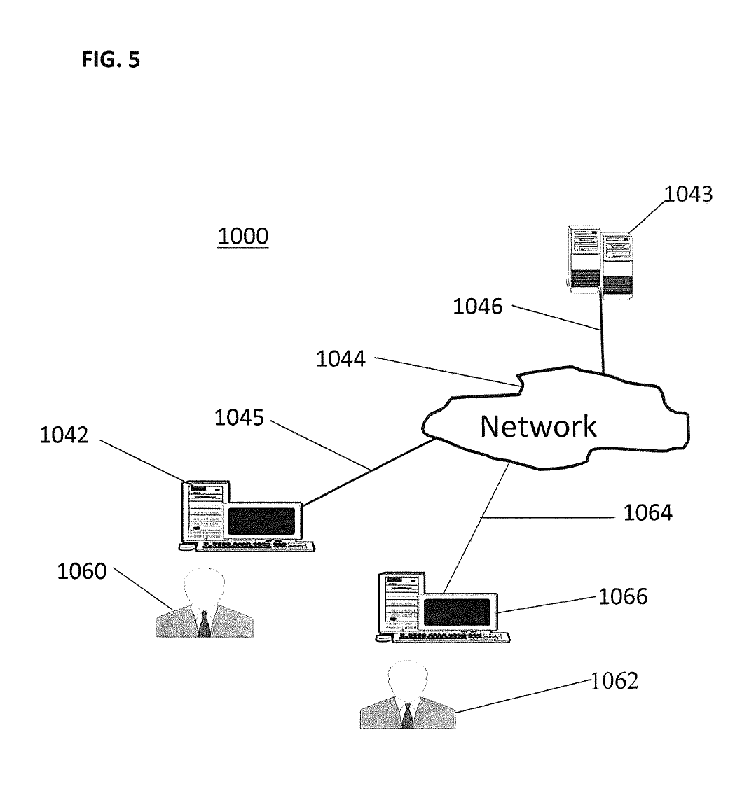

FIG. 5 is a block diagram of various example system components, in accordance with an aspect of the present invention. FIG. 5 shows a communication system 1000 usable in accordance with the present invention. The communication system 1000 includes one or more accessors 1060, 1062 (also referred to interchangeably herein as one or more “users”) and one or more terminals 1042, 1066, each of the terminals 1042, 1066 including, for example, an engaged device and a coupled casing. In one aspect, data for use in accordance with the present invention is, for example, input and/or accessed by accessors 1060, 1062 occurs via terminals 1042, 1066, wherein the engaged device includes a personal computer (PC), a laptop computer, a minicomputer, mainframe computer, microcomputer, telephonic device, or wireless device, such as a personal digital assistant (“PDA”) or other hand-held wireless device. Data accessed may be located at a server 1043, such as a PC, minicomputer, mainframe computer, microcomputer, or other device having a processor and a repository for data and/or connection to a repository for data, via, for example, a network 1044, such as the Internet or an intranet, and access via the terminals 1042, 1066 may occur via couplings 1045, 1046, 1064. The couplings 1045, 1046, 1064 include, for example, wired, wireless, or fiberoptic links. In another aspect, the method and system in accordance with aspects of the present invention operate in a stand-alone environment, such as on a single terminal.

While aspects of this invention have been described in conjunction with the example features outlined above, various alternatives, modifications, variations, improvements, and/or substantial equivalents, whether known or that are or may be presently unforeseen, may become apparent to those having at least ordinary skill in the art. Accordingly, the example aspects of the invention, as set forth above, are intended to be illustrative, not limiting. Various changes may be made without departing from the spirit and thereof. Therefore, aspects of the invention are intended to embrace all known or later-developed alternatives, modifications, variations, improvements, and/or substantial equivalents.

What is claimed is:

1. A system for providing access to a resource for an engaged device, the system comprising:
an interface coupleably engageable with the engaged device via a coupling port; and
an access port on the interface configured to coupleably engage the interface with the resource;
wherein the engaged device is functionally coupled with the resource via the interface and the access port.

2. The system of claim 1, wherein the interface comprises a case configured to hold the engaged device.

3. The system of claim 2, wherein the access port is contained within the case.

4. The system of claim 1, wherein the engaged device comprises a smart device.

5. The system of claim 4, wherein the engaged device comprises one of a smart telephone and a tablet.

6. The system of claim 1, wherein the coupling port comprises at least one of a power input port of the engaged device, an earphone port of the engaged device and a pin connector of the engaged device.

7. The system of claim 1, wherein the access port comprises at least one of a USB port, an FMI interface and a Micro SD port.

8. The system of claim 1, wherein the resource is coupled to the access port via a network.

9. The system of claim 1, wherein the engaged device is configured to be prevented from directly accessing the resource.

10. A method for providing access to a resource for an engaged device comprising:
coupling the engaged device to an interface via a coupling port;
coupling the interface to the resource via an access port; and
transmitting content between the resource and the engaged device via the coupling port and the access port.

11. The method of claim 10, wherein coupling the engaged device to the interface comprises at least partially enclosing the engaged device in a casing.

12. The method of claim 11, wherein at least partially enclosing the engaged device in a casing comprises retaining a smart device in the casing.

13. The method of claim 10, wherein coupling the engaged device to the interface comprises coupling the engaged device to the interface via at least one of a power input port of the engaged device, an earphone port of the engaged device and a pin connector of the engaged device.

14. The method of claim 10, wherein coupling the interface to the resource comprises coupling the interface to the resource via at least one of a USB port, an FMI interface and a Micro SD port.

15. A system for providing access to a resource for an engaged device, the system comprising:
means for coupling the engaged device to an interface via a coupling port;
means for coupling the interface to the resource via an access port; and
transmitting content between the resource and the engaged device via the coupling port and the access port.

16. A system for providing access to a resource from an engaged device, the system comprising:
a processor;
a user interface functioning via the processor; and
a repository accessible by the processor; wherein
the engaged device is coupled to an interface via a coupling port;
the interface is coupled to the resource via an access port; and
content between the resource and the engaged device is transmitted via the coupling port and the access port.

17. The system of claim 16, wherein the processor is housed on a server selected from a group consisting of a personal computer, a minicomputer, a microcomputer, and a main frame computer.

18. The system of claim 16, wherein the server is coupled to a network via a coupling selected from a group consisting of a wired connection, a wireless connection, and a fiberoptic connection.

19. A computer program product comprising a non-transitory computer usable medium having control logic stored therein for causing a computer to provide access to a resource from an engaged device, the control logic comprising:
computer readable program code means for coupling the engaged device to an interface via a coupling port;
computer readable program code means for coupling the interface to the resource via an access port; and
computer readable program code means for transmitting content between the resource and the engaged device via the coupling port and the access port.
